(19) United States
(12) Patent Application Publication
(10) Pub. No.: US 2018/0096033 A1
(43) Pub. Date: Apr. 5, 2018

(54) QUERY MANAGEMENT IN DATABASE MANAGEMENT SYSTEMS

(71) Applicant: International Business Machines Corporation, Armonk, NY (US)

(72) Inventors: Samar T. Desai, Pune (IN); Dattatreya Govindappanavar, Hirekerur (IN); Kapish Kumar, Bangalore (IN)

(21) Appl. No.: 15/285,139

(22) Filed: Oct. 4, 2016

(51) Int. Cl. G06F 17/30

(52) U.S. Cl. CPC G06F 17/30469; G06F 17/30463

(57) ABSTRACT

A method includes receiving a database query, analyzing system and session level variables to provide one or more identified variables, wherein each of the one or more identified variables corresponds to a system level variable or session level variable, determining if an optimizer changes setting is enabled, wherein the optimizer changes setting dictates whether or not existing variable values will be adjusted, identifying a selected value corresponding to each identified variable according to a cost analysis responsive to determining the optimizer changes setting is enabled, setting each identified variable to the corresponding selected value, and executing the received database query according to the one or more identified values. A computer program product and computer system corresponding to the method are also disclosed.

### BACKGROUND OF THE INVENTION

The present invention relates generally to the field of database management systems, and more specifically to improving query performance within database management systems.

Database management systems are computer programs that interact with a user, other applications, and a database itself to capture and analyze data. A general-purpose DBMS is designed to allow the definition, creation, querying, updating, and administration of databases. A database is an organized collection of data, often organized to model aspects of reality in a way that supports accessing relevant information.

### SUMMARY

As disclosed herein, a method includes receiving a database query, analyzing system and session level variables to provide one or more identified variables, wherein each of the one or more identified variables corresponds to a system level variable or session level variable, determining if an optimizer changes setting is enabled, wherein the optimizer changes setting dictates whether or not existing variable values will be adjusted, identifying a selected value corresponding to each identified variable according to a cost analysis responsive to determining the optimizer changes setting is enabled, setting each identified variable to the corresponding selected value, and executing the received database query according to the one or more identified values. A computer program product and computer system corresponding to the method are also disclosed.

### BRIEF DESCRIPTION OF THE DRAWINGS

FIG. 1 is a block diagram depicting a database system in accordance with one embodiment of the present invention;

FIG. 2 is a flowchart depicting a database query optimization method in accordance with one embodiment of the present invention; and

FIG. 3 depicts a block diagram of components of a computer, in accordance with some embodiments of the present invention.

### DETAILED DESCRIPTION

Database management systems (DBMS) can require tremendous resources to handle heavy workloads. Increased microprocessor performance coupled with improved memory management systems have improved the number of queries that a particular microprocessor can perform in a given unit of time. Additionally, the use of multiple microprocessors and multiple networked computers has further increased the capacity of many database management systems. Most database management systems have provided session and system level variables for users to set to improve the performance of certain types of queries. When implemented incorrectly, these session/system level variables can result in bad query performance. In such cases, manual intervention is required to change these variables. This is a trial and error method, which can involve numerous unnecessary iterations.

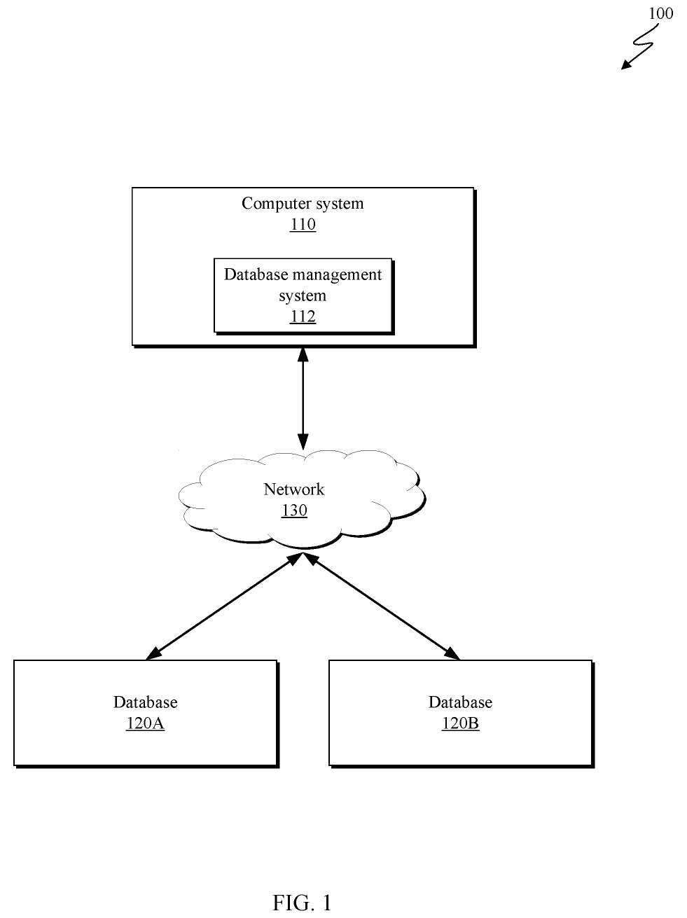

FIG. 1 is a block diagram depicting a database system 100 in accordance with at least one embodiment of the present invention. As depicted, database system 100 includes a computer system 110, databases 120, and a network 130. Database system 100 may be an example of a system whose queries may be optimized using a query optimization method such as the one disclosed.

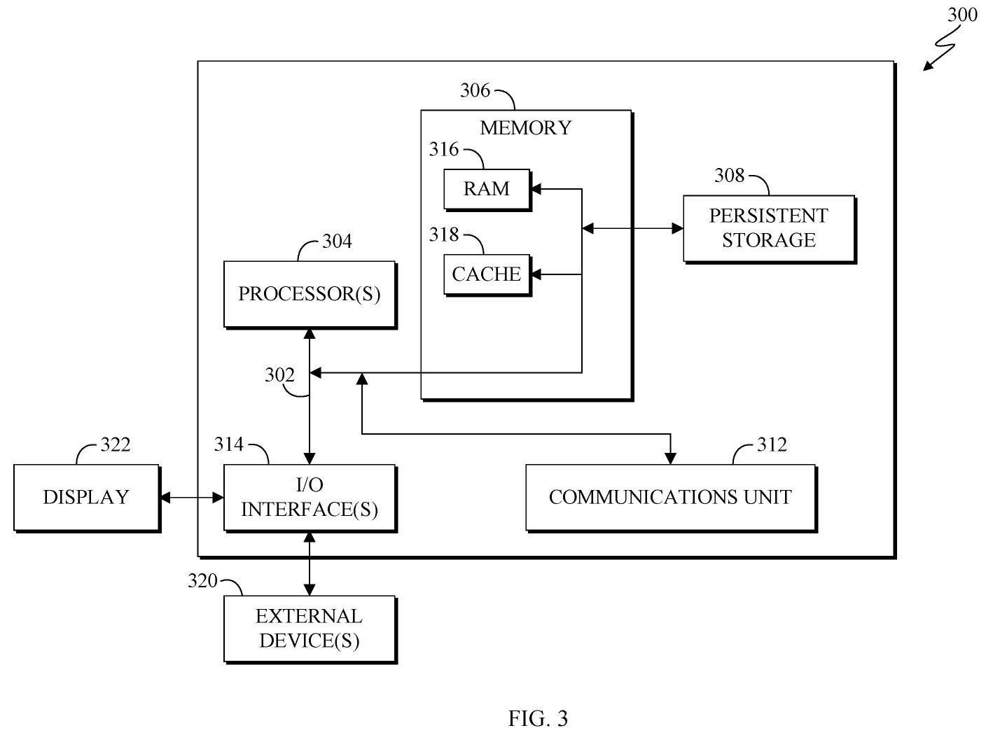

Computer system 110 can be a desktop computer, a laptop computer, a specialized computer server, or any other computer system known in the art. In some embodiments, computer system 110 represents a computer system utilizing clustered computers and components to act as a single pool of seamless resources. In general, computer system 110 is representative of any electronic device, or combination of electronic devices, capable of executing machine-readable program instructions, as described in greater detail with regard to FIG. 3.

As depicted, computer system 110 includes a database management system 112. Database management system 112 may be a set of computer software that allows a user to interact with one or more databases and provides access to data contained in the databases. Database management system 112 may provide various functions that allow entry, storage, and retrieval of large quantities of information. In some embodiments, database management system 112 provides means for managing how information stored in the databases is stored. The functions provided by database management system 112 may fall into four categories: data definition, update, retrieval, and administration. Data definition functions include creation, modification, and removal of definitions that define the organization of the data. Update functions may include insertion, modification, and deletion of the actual data. Retrieval functions may include providing information in a form directly usable or for further processing by other applications. The retrieved data may be made available in the same form as it is stored in the database or in a new form obtained by altering or combining existing data from the database. Administration functions may include registering and monitoring users, enforcing data security, monitoring performance, maintaining data integrity, dealing with concurrency control, and recovering information that has been corrupted.

Databases 120 may be collections of information that are organized to be easily accessed, managed, and updated. In one embodiment, databases 120 are classified according to the types of content they contain. Databases 120 may be classified according to their organizational approach. For example, a relational database is a tabular database in which data is defined such that it can be reorganized and accessed in a number of different ways. A distributed database is one that can be dispersed or replicated among different points in a network. An object-oriented programming database is one that is congruent with the data defined in object classes and subclasses.

Network 130 can be, for example, a local area network (LAN), a wide area network (WAN) such as the Internet, or a combination of the two, and include wired, wireless, or fiber optic connections. In general, network 130 can be any combination of connections and protocols that will support communications between computer system 110 and databases 120 in accordance with an embodiment of the present invention. In at least one embodiment of the present invention, network 130 transmits queries and data between computer system 110 and databases 120.

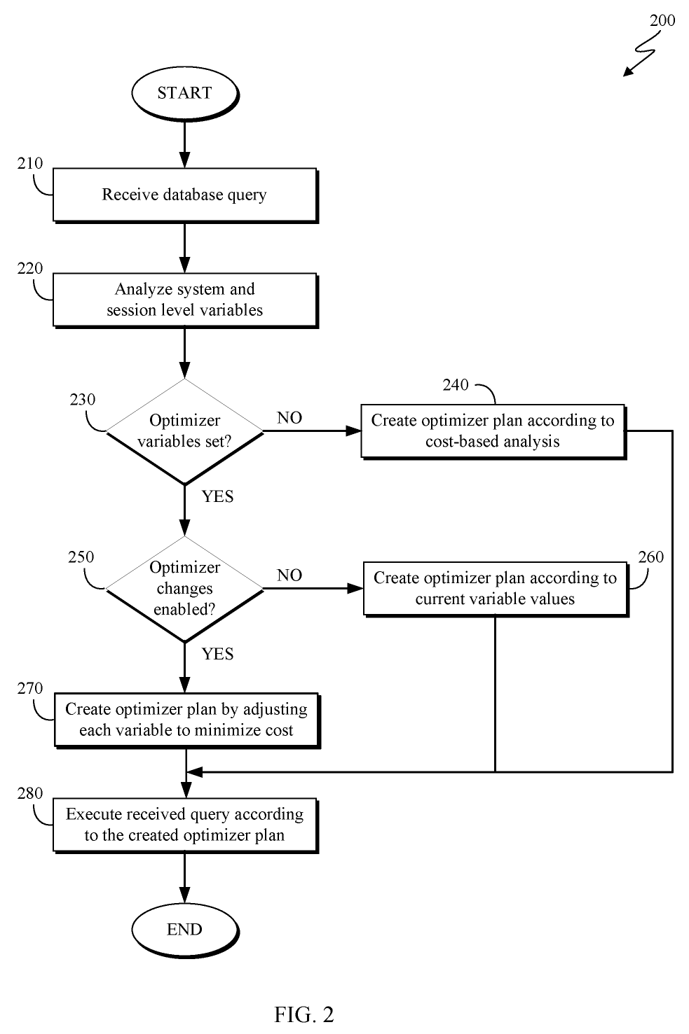

FIG. 2 is a flowchart depicting a database query optimization method 200 in accordance with at least one embodiment of the present invention. As depicted, database query optimization method 200 includes receiving (210) a database query, analyzing (220) system and session level variables, determining (230) if optimizer variables are set, creating (240) an optimizer plan indicating each identified variable, determining (250) if optimizer changes are enabled, adjusting (260) optimizer plan values according to cost analysis, adjusting (270) identified variables according to the optimizer plan, and executing (280) the received query. Database query optimization method 200 may enable queries to be executed more efficiently.

Receiving (210) a database query may include receiving a user initiated query on the database. Database queries, such as SQL queries, make use of a declarative select statement to retrieve data from one or more tables or expressions. Queries allow a user to describe desired data, leaving the database management system to carry out planning, optimizing, and performing the physical operations necessary to produce that result. The received query may include a list of columns to include in the final result. The received query may also include keywords and clauses such as a “FROM” clause, a “WHERE” clause, a “GROUP BY” clause, a “HAVING” clause, an “ORDER BY” clause, or a “DISTINCT” clause. A “FROM” clause indicates which table or tables to retrieve data from, and may include optional “JOIN” sub-clauses to indicate rules for joining tables. A “WHERE” clause may include a comparison predicate, which restricts the rows returned by the query. A “GROUP BY” clause projects rows having common values into a smaller set of rows. A “HAVING” clause includes a predicate used to filter rows resulting from the “GROUP BY” clause. An “ORDER BY” clause identifies which column or columns to use to sort the resulting data, and which direction to sort them. A “DISTINCT” clause or keyword eliminates duplicate data.

Analyzing (220) system and session level variables may include detecting environment variables that are persisted system-wide or session-wide. Environment variables may be a set of dynamic named values that can affect the way running process will behave on a computer. These variables may be set at a global level so they are available for all database queries. Analyzing (220) system and session level variables may further include identifying one or more system/session level variables that correspond to the received database query. The received database query may directly indicate one or more system/session level variables.

Determining (230) if optimizer variables are set may include determining whether or not any values have been set for the analyzed system and session level variables. In one embodiment, the optimizer variable values can be set manually by a user. The optimizer variable values may be set automatically, or may be values persisting from a previous query execution. If no optimizer plan exists, it is assumed the optimizer variables are not set. If it is determined the optimizer variables are set (230, yes branch), the method continues by determining (250) if optimizer changes are enabled. If it is determined the optimizer variables are not set (230, no branch), the method continues by creating (240) an optimizer plan according to a cost-based analysis.

Creating (240) an optimizer plan according to a cost-based analysis may include receiving one or more cost-analysis results corresponding to the analyzed system and session level variables. In some embodiments, a DBMS may have one or more generic optimizer plans available. For example, an optimizer plan may exist for a general query type, indicating a set of optimized variable values for said query type. These optimized variable values may be determined according to a cost-based analysis of running a set of sample queries under various variable conditions to determine the most cost-efficient variable values. In such embodiments, creating (240) an optimizer plan according to a cost-based analysis includes setting current optimizer plan variables to the values indicated by the existing optimizer plan for the received query type. The created optimizer plan may be saved for future use. In some embodiments, the created optimizer plan is saved and tagged with the query type such that it may be easily located and used for similar queries in the future.

Determining (250) if optimizer changes are enabled may include determining if an optimizer changes setting has been enabled or disabled. If it is determined optimizer changes are not enabled (250, no branch), the method continues by creating (260) an optimizer plan according to current variable values. If it is determined optimizer changes are enabled (250, yes branch), the method continues by executing (280) the received query according to the current variables.

Creating (260) an optimizer plan according to current variable values may include creating an optimizer plan that reflects the current variable conditions. In some embodiments, the current variable values may correspond to values that have been manually inputted by a user. In such embodiments, creating (260) an optimizer plan according to the current variable values allows the user to save said optimizer plan and recreate the same variable conditions for later queries. The created optimizer plan reflecting the current variable values may act as a baseline or starting point in cases where the method is executed multiple times. The created optimizer plan may be saved for future use. In some embodiments, the created optimizer plan is saved and tagged with the query type such that it may be easily located and used for similar queries in the future.

Creating (270) an optimizer plan by adjusting each variable to minimize cost may include conducting a cost analysis with respect to each system/session level variable. In one embodiment, with respect to a Boolean variable, the variable is toggled, and a cost analysis is conducted for each of its possible outcomes. Creating (270) optimizer plan values in this case includes identifying the variable value for which the cost analysis is lower, and including this value in the optimizer plan. For a non-Boolean variable, the variable is changed to different values moving in each direction (increasing and decreasing) until a local minimum efficiency is reached. For example, if a variable's current value is 6, a cost analysis may be executed for the variable being set to 5 and set to 7. If the cost analysis is lower for the variable being set to 7, a separate cost analysis is carried out with the variable set to 8, 9, 10, etc., until a local minimum is reached and the cost analysis begins to increase. The variable value indicated by the optimizer plan is the value corresponding to the local minimum. This variable adjustment process may then be repeated for each identified system and session level variable. The created optimizer plan may be saved for future use. In some embodiments, the created optimizer plan is saved and tagged with the query type such that it may be easily located and used for similar queries in the future.

Executing (280) the received query according to current variables may include setting each of the system and session level variables to the value indicated by the relevant optimizer plan. The received query may then be executed by the DBMS under the conditions indicated by the optimizer plan.

FIG. 3 depicts a block diagram of components of computer 300 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

As depicted, the computer 300 includes communications fabric 302, which provides communications between computer processor(s) 304, memory 306, persistent storage 308, communications unit 312, and input/output (I/O) interface(s) 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses. Memory 306 and persistent storage 308 are computer-readable storage media. In this embodiment, memory 306 includes random access memory (RAM) 316 and cache memory 318. In general, memory 306 can include any suitable volatile or non-volatile computer-readable storage media.

One or more programs may be stored in persistent storage 308 for access and/or execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 312, in these examples, provides for communications with other data processing systems or devices. In these examples, communications unit 312 includes one or more network interface cards. Communications unit 312 may provide communications through the use of either or both physical and wireless communications links.

I/O interface(s) 314 allows for input and output of data with other devices that may be connected to computer 300. For example, I/O interface 314 may provide a connection to external devices 320 such as a keyboard, keypad, a touch screen, and/or some other suitable input device. External devices 320 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 308 via I/O interface(s) 314. I/O interface(s) 314 also connect to a display 322.

Display 322 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1-7. (canceled)

8. A computer program product comprising:
one or more computer readable storage media and program instructions stored on the one or more computer readable storage media, the program instructions comprising instructions to:
receive a database query;
analyze system and session level variables to provide one or more identified variables, wherein each of the one or more identified variables corresponds to a system level variable or session level variable;
determine if an optimizer changes setting is enabled, wherein the optimizer changes setting dictates whether or not existing variable values will be adjusted;
identify a selected value corresponding to each identified variable according to a cost analysis responsive to determining that the optimizer changes setting is enabled; and
execute the received database query according to the one or more identified values subsequent to setting each identified variable to the corresponding selected value.

9. The computer program product of claim 8, wherein instructions to analyze system and session level variables comprise instructions to identify system and session level variables that affect the execution of the received database query.

10. The computer program product of claim 8, further comprising instructions to provide a user interface enabling a user to select whether or not to enable an optimizer changes setting.

11. The computer program product of claim 8, further comprising instructions to analyze an operating cost associated with one or more selected values for each identified variable.

12. The computer program product of claim 8, further comprising instructions to create an optimizer plan indicating the selected values for the identified variables and the received database query.

13. The computer program product of claim 12, further comprising instructions to store the created optimizer plan.

14. The computer program product of claim 8, wherein identifying a selected value for an identified variable comprises executing sample queries for multiple values for the identified variable and selecting the value for which the operational cost of the query is lowest.

15. A computer system comprising:
one or more computer processors;
one or more computer-readable storage media;
program instructions stored on the computer-readable storage media for execution by at least one of the one or more processors, the program instructions comprising instructions to:
receive a database query;
analyze system and session level variables to provide one or more identified variables, wherein each of the one or more identified variables corresponds to a system level variable or session level variable;
determine if an optimizer changes setting is enabled, wherein the optimizer changes setting dictates whether or not existing variable values will be adjusted;
identify a selected value corresponding to each identified variable according to a cost analysis responsive to determining that the optimizer changes setting is enabled; and
execute the received database query according to the one or more identified values subsequent to setting each identified variable to the corresponding selected value.

16. The computer system of claim 15, wherein instructions to analyze system and session level variables comprise instructions to identify system and session level variables that affect the execution of the received database query.

17. The computer system of claim 15, further comprising instructions to provide a user interface enabling a user to select whether or not to enable an optimizer changes setting.

18. The computer system of claim 15, further comprising instructions to analyze an operating cost associated with one or more selected values for each identified variable.

19. The computer system of claim 15, further comprising instructions to create an optimizer plan indicating the selected values for the identified variables and the received database query.

20. The computer system of claim 15, wherein identifying a selected value for an identified variable comprises executing sample queries for multiple values for the identified variable and selecting the value for which the operational cost of the query is lowest.
